(19) United States
(12) Patent Application Publication
(10) Pub. No.: US 2005/0017850 A1
(43) Pub. Date: Jan. 27, 2005

(54) Mechanical measuring device and a measuring method

(75) Inventor: Seppo Nissila, Oulu (FI)

Correspondence Address: HOFFMANN & BARON, LLP, 6900 JERICHO TURNPIKE, SYOSSET, NY, 11791, US

(73) Assignee: Polar Electro Oy.

(21) Appl. No.: 10/878,644

(22) Filed: Jun. 28, 2004

(30) Foreign Application Priority Data
Jul. 4, 2003 (FI) 20031021

(51) Int. Cl. H04B 3/36

(52) U.S. Cl. 340/407.1

(57) ABSTRACT

The invention relates to a mechanical measuring device for measuring user-related data. A measuring device can be positioned in connection with a portable electronic device. The measuring device comprises a mechanical measuring scale and a mechanical pointer pointing at each measuring scale, and the measuring scale and the pointer of the corresponding measuring scale are arranged to move relative to each other. Indicating means generate regular mechanical vibrations when the measuring scale and the pointer of the corresponding measuring scale are moved relative to each other. The pointer is arranged to be used in such a way that it is adjusted to indicate the value corresponding to the user-related data on the measuring scale by means of the regular mechanical vibrations generated by the indicating means.

### FIELD

The invention relates to a mechanical measuring device and a measuring method for measuring and storing data related to human activity.

### BACKGROUND

There are a variety of known solutions for measuring data related to human activity, such as the amount of energy in the food taken in and the exercise. For example, the amount of energy in the food taken in per day can be measured by writing down the amount of energy at each intake time separately, and the total can then be summed up. This solution is not very convenient, however, because the user always needs a pen and paper that cannot be used on all occasions or that may get lost. In addition, the data cannot be stored unnoticeably, but it requires concentration and focusing of the eyes on the writing.

Data can also be input to an electronic device for measuring. In such a case, the data must be keyed in by means of a keyboard functioning as the user interface. This is complex, however, because input of data may require complex key combinations or selection of the most appropriate one from several menus, the appropriate one making the input of data possible. Further, this solution does not allow data to be input unnoticeably either, but it, too, requires concentration and focusing of the eyes on the key entry and the characters on the display.

### BRIEF DESCRIPTION

An object of the invention is to implement an improved solution in which input of data to a measuring device is carried out simply and unnoticeably.

This is achieved with a mechanical measuring device for measuring user-related data. The measuring device comprises: at least one mechanical measuring scale and at least one mechanical pointer pointing at each measuring scale, and each measuring scale and the at least one pointer of the corresponding measuring scale are arranged to move relative to each other; and indicating means for generating regular mechanical vibrations when each measuring scale and the at least one pointer of the corresponding measuring scale are moved relative to each other; and the at least one pointer being arranged to be used in such a way that the pointer is adjusted to indicate the value that corresponds to the user-related data on said at least one measuring scale by means of the regular mechanical vibrations generated by the indicating means.

The invention also relates to a measuring method for measuring user-related data by means of a mechanical measuring device. The measuring device comprises at least one mechanical measuring scale and at least one mechanical pointer pointing at each measuring scale, and each measuring scale and the at least one pointer of the corresponding measuring scale are arranged to move relative to each other; and indicating means for generating regular mechanical vibrations when each measuring scale and the at least one pointer of the corresponding measuring scale are moved relative to each other; and adjusting the at least one pointer to indicate the value that corresponds to the user-related data on said at least one measuring scale by means of the regular mechanical vibrations generated by the indicating means.

Preferred embodiments of the invention are described in the dependent claims.

A plurality of advantages is achieved with the measuring device and method according to the invention. A mechanical measuring device is a working solution in practice, because the measurement can be carried out easily and the input of data is simple, unnoticed and secure, and does not require focusing of the eyes on the device.

### LIST OF FIGURES

The invention will now be described in more detail in connection with preferred embodiments, with reference to the attached drawings, of which

FIG. 1A shows an electronic device comprising a mechanical measuring device;

FIG. 1B shows a side view of an electronic device;

FIG. 1C shows an electronic device whose mechanical measuring device has a fixed scale and a moving pointer;

FIG. 2A shows an electronic device comprising a two-circle measuring device;

FIG. 2B shows a two-circle measuring device; and

FIG. 3 shows a measuring device having a rectangular structure.

### DESCRIPTION OF EMBODIMENTS

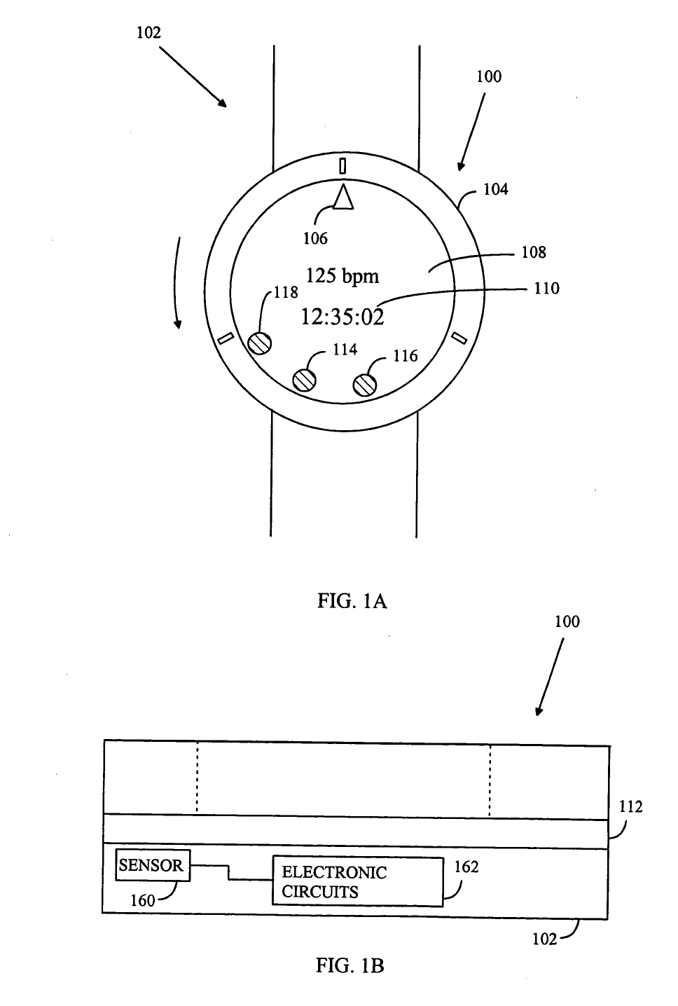

Let us now study a mechanical measuring device according to the solution shown in FIGS. 1A, 1B and 1C. A measuring device 100 is positioned in connection with an electronic device 102. The electronic device 102 may be, for instance, a device measuring the functioning of one member and attached to the wrist, such as a pulse counter, watch, computer, telecommunications device, electronic compass, altimeter, positioning device, pace counter, speed indicator, a combination of at least two of the above or the like.

The measuring device comprises a mechanical measuring scale 104 operated manually and a mechanical pointer 106 pointing at the measuring scale 104. In a general case, the measuring device may comprise more than one measuring scale and one pointer. The measuring scale 104 may be a numeric interval scale or a relative scale between the minimum value and the maximum value. The minimum value may be 0 and the maximum value in measuring the energy content of food may be 3 000 kcal, for example, and in measuring physical exercise the maximum value may be from some kilometres to dozens of kilometres (e.g. 50 km) according to the extent of exercise desired by the user. In the solution of FIG. 1, the immovable pointer 106 is positioned on glass or another transparent window 108, which covers the display 110 of an electronic device. The pointer 106 may also be a character for indicating time or the like on the panel of the watch-like electronic device. When the ring-like measuring scale 104 is turned in the direction shown with an arrow in FIG. 1, the reading indicated by the pointer 106 on the measuring scale 104 increases.

The measuring device also comprises indicating means 112 for producing regular mechanical vibrations when each measuring scale and at least one pointer of the corresponding measuring scale are moved relative to each other. The mechanical vibrations may be changes in the kinetic resistance which the user can feel with fingers, or sounds heard by the user (clicks), or both. The indicating means 112 may be implemented for instance by means of one or more springs and tooth systems (not shown in FIGS. 1A, 1B, 1C), which cause clicking sounds or changes in the kinetic resistance, but the solution presented is not restricted to how the mechanical vibrations of the indicating means are generated. There may be dozens of mechanical vibrations in one round. The pointer 106 is focused, by means of the mechanical vibrations generated by the indicating means 112, to point at that value on the measuring scale 104 which represents user-related data.

For example, the daily amount of energy taken in can be controlled as follows. When the user eats for the first time in the morning, the measuring scale 104 is turned in the direction of the arrow in such a way that the pointer 106 moves from zero to the point indicating the amount of energy in the food (e.g. 800 kcal). To input the amount of energy to the measuring device is simple and can be done unnoticeably, because the regular mechanical vibrations of the indicating means 112 inform the user of the extent of turning of the measuring scale 104 without the user having to look at the measuring device. The interval between two mechanical vibrations may correspond to 100 kcal, for example. Thus, inputting 800 kcal requires 8 mechanical vibrations that can be heard or felt with fingers, or both heard and felt. Mechanical vibrations can also correspond to more accurate division, such as 25 kcal. When the user eats for the second time, the measuring scale 104 is turned further by the amount of energy in the food. If the amount of energy at the second time is 1 200 kcal, the measuring scale 104 is turned forwards from the value of 800 kcal at the pointer 106, so that the pointer 106 moves on to point at the value of 800 kcal+1 200 kcal=2 000 kcal. The rest of the energy portions taken in are input to the measuring device in a similar way, and the total amount of energy can be seen in the evening. In this way, the energy can be measured cumulatively with the measuring scale 104 and the pointer 106. Instead of one day, the time window can be any interval. The measuring scale must be dimensioned in such a way that the highest value is not exceeded within the time window. Alternatively, two annular measuring scales within each other may be used, the scales being connected to each other in such a way that a full round of the first measuring scale increases the reading indicated on the second measuring scale. There may also be more than two measuring scales positioned within each other and functioning in a similar manner.

The user-related data may also be the value of the physical exercise by the user. In such a case, the value of the exercise to be measured, indicated by the pointer, is added cumulatively in connection with each physical exercise by the amount of exercise.

The measuring scale 104 may also comprise a target value pointer 114, the value of which the user should aim at. The target value may be the amount of energy that the user may take in at the most. Alternatively, the target value may be the amount of energy that the user must at least take in during the measurement. The target value may also be the number of kilometres to be run, duration of exercise, number of exercise times, total of the weights lifted in weight training or the like. The target value may also be the value between the upper limit and the lower limit indicated by the target value pointers 116, 118.

The regularity of the mechanical vibrations of the indicating means 112 may correspond to a scale adapted according to the mechanical measuring scale. In such a case, the measuring scale may be divided into intervals of 100 kcal, the interval of the mechanical vibrations of the indicating means thus corresponding to 100 kcal.

Alternatively, the regularity of mechanical vibrations of the indicating means may correspond to a scale that deviates from the mechanical measuring scale in a predetermined manner. Thus, the measuring scale may be divided into intervals of 100 kcal, but the interval of the mechanical vibrations of the indicating means may, for instance, correspond to a value on a kJ scale or a value represented by points of portions of food applying a point system, in which case, for example, one point corresponds to 30 kcal. In this way, the user can input the amount of energy with a scale he/she understands the best, but the data processing can be carried out with another scale.

The structure of the measuring device may be such that at least one measuring scale is positioned in a ring which rotates and is positioned in a portable electronic device, and at least one pointer pointing at the measuring scale is positioned fixedly in an electronic device, as illustrated in FIGS. 1A and 1B. Alternatively, at least one pointer 106 is positioned in a ring which rotates and is positioned in a portable electronic device, and at least one measuring scale 104 is positioned fixedly in the electronic device 100, as shown in FIG. 1C.

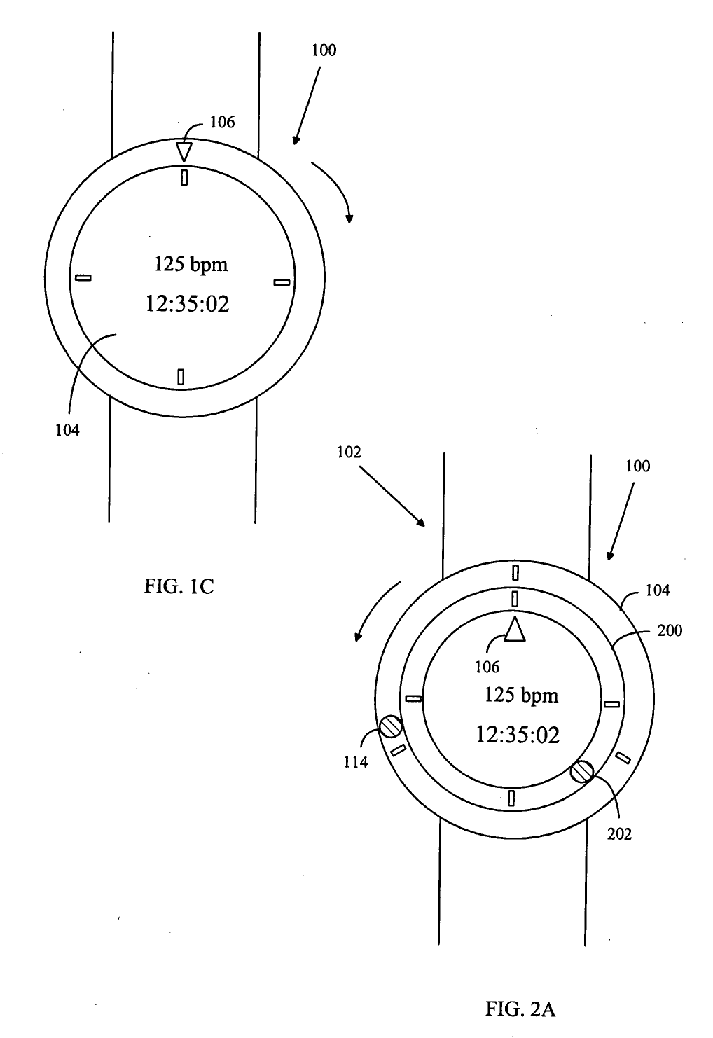

In a general case, there may be several measuring scales and pointers. In such a case, each measuring scale and at least one pointer of the corresponding measuring scale is arranged to move relative to each other, whereby the measuring scale may move and the pointer be fixed, or the pointer may move and the measuring scale be fixed. In the case of FIG. 2A, there are two measuring scales but only one pointer 106. The first measuring scale 104 measures the energy taken in, and a second measuring scale 200 measures the length of the distance run. The target value pointer 114 points at the amount of energy aimed at, and a target value pointer 202 points at the amount of physical exercise per day (or another time window desired).

In an embodiment of the invention, the measuring scale and the pointer can be implemented for instance by means of two discs upon each other, as shown in FIG. 2B, in such a way that the periphery of the lower disc 104 comprises readings only one of which is visible at a time from an opening 210 of the disc 106 on top. The disc 106 on top functions as a pointer, the disc 104 below functioning as a measuring scale. When the discs are rotated relative to each other, any reading of the measuring scale disc can be shown to the user by means of the pointer disc.

Generally, the pointer may be a piece covering the measuring scale, comprising an opening for indicating one reading on the measuring scale. Such a solution can be applied not only to round measuring device structures, but also to other structures.

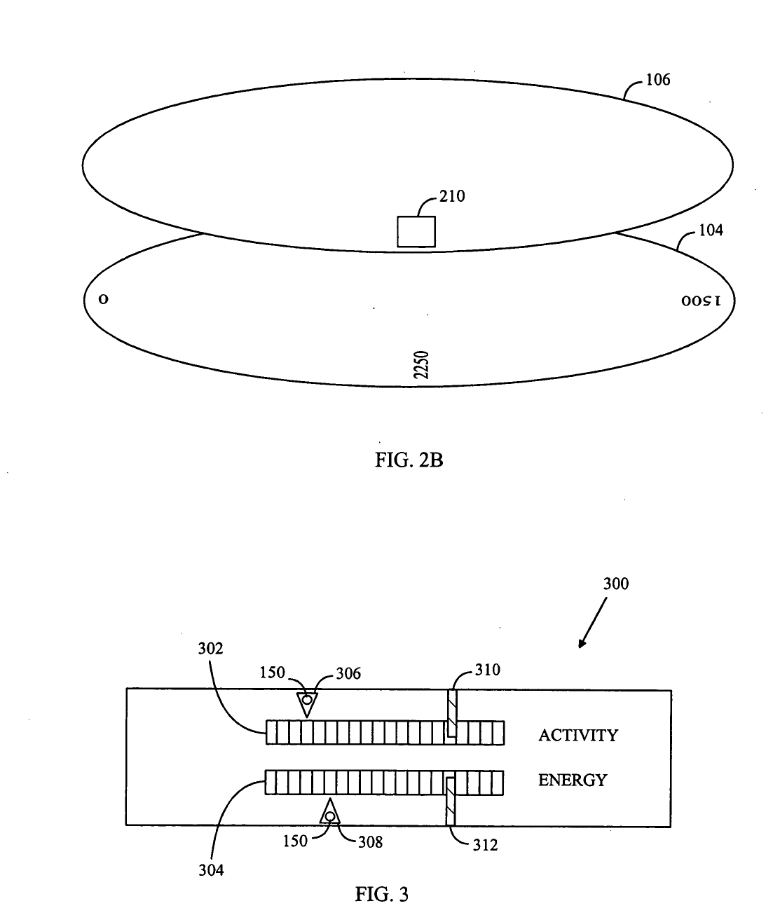

Instead of round measuring device solutions, the measuring scale may be positioned in a rectangular structure, as shown in FIG. 3. A rectangular structure 300 may also comprise a plurality of measuring scales and pointers. FIG. 3 shows a measuring scale 302 for physical exercise and a measuring scale 304 for the energy content of food. Both the pointer 306 for physical exercise and the pointer 308 for the energy content of food may be attached to the rectangular structure 300 by means of sliding restrain, and the pointers 306, 308 may move in straight line in the direction of their respective measuring scales. Target value pointers 310, 312 can be used to indicate the amount of physical exercise or energy that is aimed at within a desired time window. The rectangular structure 300 may be positioned in the wristband of an electronic device attached to the user's wrist, for example.

In an embodiment of the invention, both the amount of energy taken in and the physical exercise are measured with the same scale. In this case, the reading indicated by the pointer on the measuring scale is increased according to the amount of energy taken in, and correspondingly, the reading indicated by the pointer on the measuring scale is decreased according to physical exercise. Energy expenditure and energy intake thus affect in opposite directions (wherefore the reading on the measuring scale can also be increased according to the expenditure and decreased according to the energy taken in). This is convenient when physical exercise is measured with the amount of energy burnt off, because in this way the balance of energy intake and energy expenditure can be controlled. For example, when the user burns off as much energy per day as he/she takes in, the measuring scale indicates zero, which allows the user to keep his/her weight unchanged. When taking more exercise than usual, the user can eat more, and correspondingly, when taking less exercise than usual, the user can eat less.

In the solution presented, the measuring scale or pointer intended to be movable can be locked in place to prevent unintentional displacement. In such a case, the measuring device comprises a stop 150, which in its stop position prevents the movable part from moving. Once the stop 150 is opened, the pointer and measuring scale can be moved relative to each other. The stop 150 may be a button provided with a spring mechanism and being pressed inwards when the pointer and the measuring scale are moved relative to each other. When the pressing is stopped, the spring lifts the button up and locks the pointer and measuring scale. The stop may also be a screw that is unfastened to enable movement of the pointer and the measuring scale. Fastening the screw prevents movement.

The reading of the measuring scale can be moved manually by keying it in to a program of an electronic device. However, in one embodiment, the measuring device may comprise means 160 for converting the data indicated by the mechanical measuring device into electronic form and for transmitting the data in the electronic form to electronic circuits 162 of the electronic device. In this case, the piezoelectric sensor of the electronic device in the means 160 can detect the mechanical vibrations generated by the movement of the measuring scale and the pointer relative to each other as well as the sound caused by the vibrations. An electronic circuit connected to the piezoelectric sensor amplifies the signal, detects the pulses and calculates them. On the basis of the pulses, it can be determined which value is indicated by the pointer on the measuring scale.

Each measuring scale of the measuring device may be either an interval scale or a relative scale. On an interval scale, the values are in the order of magnitude, the distances between the values being meaningful with respect to the magnitude differences. The zero point of an interval scale has been selected arbitrarily, however, and the value relations cannot thus be determined in a meaningful way. In a relative scale, the zero point is absolute, and in addition to the features of an interval scale, also the value relations can be determined.

Although the invention has been described above with reference to the example of the attached drawings, it is obvious that it is not restricted to this example but may be varied in a plurality of ways within the scope of the attached claims.

1. A mechanical measuring device for measuring user-related data, wherein the measuring device comprises:
at least one mechanical measuring scale and at least one mechanical pointer pointing at each measuring scale, and each measuring scale and the at least one pointer of the corresponding measuring scale are arranged to move relative to each other; and
indicating means for generating regular mechanical vibrations when each measuring scale and the at least one pointer of the corresponding measuring scale are moved relative to each other; and
the at least one pointer being arranged to be used in such a way that the pointer is adjusted to indicate the value that corresponds to the user-related data on said at least one measuring scale by means of the regular mechanical vibrations generated by the indicating means.

2. A measuring device according to claim 1, wherein the user-related data is the energy value taken in by the user, and the at least one measuring scale of the measuring device and the at least one pointer related to said measuring scale are intended for measuring energy, and the measuring device is arranged to function in such a way that the measurement is arranged to be carried out within a predetermined time window, whereby the value of the energy measured with the at least one measuring scale, indicated by means of each pointer related to energy measurement, is increased cumulatively at each intake time by the amount of energy in the food.

3. A measuring device according to claim 1, wherein the user-related data is the value of the user's physical exercise, and the at least one measuring scale of the measuring device and the at least one pointer related to said measuring scale is intended for measuring physical exercise, and the measuring device is arranged to function in such a way that the measurement is arranged to be carried out within a predetermined time window, whereby the value of the exercise measured with said at least one measuring scale, indicated by means of each pointer related to physical exercise, is increased cumulatively in connection with each physical exercise by the amount of physical exercise.

4. A measuring device according to claim 1, wherein the energy value of the food taken in by the user and the energy value of the food expended by the user are measured as the user-related data with one measuring scale of the measuring device and with at least one pointer related to said measuring scale, and the measurement with the measuring device is arranged to be carried out within a predetermined time window, whereby the value of the energy measured with said at least one measuring scale, indicated by means of each pointer related to energy measurement, is increased by the amount of energy in the food at each intake time, and the value of the energy to be measured is decreased by the amount of expended energy.

5. A measuring device according to claim 1, wherein the regularity of the mechanical vibrations of the indicating means corresponds to a scale that is adapted according to the mechanical measuring scale.

6. A measuring device according to claim 1, wherein the regularity of the mechanical vibrations of the indicating means corresponds to a scale that deviates from the mechanical measuring scale in a predetermined manner.

7. A measuring device according to claim 1, wherein at least one measuring scale is positioned in a ring that rotates and is positioned in a portable electronic device, and at least one pointer pointing at the measuring scale is positioned fixedly in the electronic device.

8. A measuring device according to claim 1, wherein at least one pointer is positioned in a ring that rotates and is positioned in a portable electronic device, and at least one measuring scale is positioned fixedly in the electronic device.

9. A measuring device according to claim 1, wherein at least one measuring scale is positioned in a rectangular structure, and at least one pointer is attached to the rectangular structure with sliding restrain, and each pointer is arranged to move in the direction of the measuring scale in the rectangular structure.

10. A measuring device according to claim 1, wherein the measuring device comprises a stop with which unintentional movement of the pointer and the measuring scale relative to each other is prevented.

11. A measuring device according to claim 1, wherein the measuring device comprises means for converting the data indicated by the mechanical measuring device operated manually into electronic form and for transmitting the data in the electronic form to electronic circuits of an electronic device.

12. A measuring device according to claim 1, wherein the pointer is a piece that covers the measuring scale, comprising an opening for indicating one reading on the measuring scale.

13. A measuring device according to claim 1, wherein the measuring device is positioned in connection with a portable electronic device measuring the functioning of at least one member.

14. A measuring method for measuring user-related data by means of a mechanical measuring device, wherein the measuring device comprises at least one mechanical measuring scale and at least one mechanical pointer pointing at each measuring scale, and each measuring scale and the at least one pointer of the corresponding measuring scale are arranged to move relative to each other; and indicating means for generating regular mechanical vibrations when each measuring scale and the at least one pointer of the corresponding measuring scale are moved relative to each other; and
adjusting the at least one pointer to indicate the value that corresponds to the user-related data on said at least one measuring scale by means of the regular mechanical vibrations generated by the indicating means.
